(19) United States
(12) Patent Application Publication
(10) Pub. No.: US 2025/0030245 A1
(43) Pub. Date: Jan. 23, 2025

(54) Managing Energy in a Network

(71) Applicant: Telefonaktiebolaget LM Ericsson (publ), Stockholm (SE)

(72) Inventors: Hossein Shokri Ghadikolaei, Täby (SE); Lackis Eleftheriadis, Valbo (SE); Amin Azari, Järfälla (SE)

(21) Appl. No.: 18/701,743

(22) PCT Filed: Oct. 22, 2021
(86) PCT No.: PCT/EP2021/079318

§ 371 Date: Apr. 16, 2024

(51) Int. Cl. H02J 3/32; H02J 7/00

(52) U.S. Cl. CPC H02J 3/32; H02J 7/0013; H02J 7/0071; H02J 2203/20

(57) ABSTRACT

There is provided a computer-implemented method for managing a plurality of energy storages at a plurality of sites in a network, the method comprising: acquiring a first dataset including power consumption data of at least a subset of the plurality of energy storages over a predetermined amount of time; generating a first simulated environment of the network based on the acquired first dataset; and training a first reinforcement learning system by performing the following steps iteratively until a termination condition is met; selecting an action from a set of feasible actions, wherein each action in the set of feasible action is bounded by a set of constraints; calculating a reward of the selected action based on the generated first simulated environment of the network; and training the first reinforcement learning system to maximise reward for a given state of the network, based on the calculated reward for the selected action.

### TECHNICAL FIELD

The present disclosure relates to the field of managing energy storages (e.g., batteries) in a network. In particular, the present disclosure relates to methods and systems for managing charging and discharging of energy storages associated with different sites or nodes of a network.

### BACKGROUND

The mobile communications sector is experiencing an ever-increasing footprint due to the introduction of new services, the massive number of devices, and higher communication requirements. Although new communication technologies offer much better bits/joules, and the massive increase in the number of users and communicated bits lead to a steady increase of carbon footprint of the sector. If the current industry trends continue, it will soon become much worse and may violate the sustainability agenda of the sector. To address this challenge, alternative techniques are needed to reduce the carbon footprint, as well as network operational costs.

The design of battery networks is addressed in the field of power systems from the perspective of distributed generations, for example in Georgilakis, Pavlos S., and Nikos D. Hatziargyriou. “Optimal distributed generation placement in power distribution networks: models, methods, and future research.” IEEE Transactions on power systems 28.3 (2013): 3720-3428. Such works are in the framework of demand response to design the distributed generations with various objectives. However, none of these works are developed for cellular networks, and thus they do not consider the network load, the locations of the Radio Base Stations (RBSs), or the load-dependent energy consumption.

United States patent application US 20210/003974 proposes an approach to maintain a constant power frequency to ensure the stability of the power grid in the presence of renewable energy sources. A machine learning model is used to generate operational rules that optimizes settings of power generation, power usage, and power storage. The status of a neighbouring electrical device, a household electrical circuit, a neighbourhood sub-station, and a power grid is passively monitored.

International patent application WO 2017/114810 presents a method of demand service, using reinforcement learning (RL), for utility network. The control action and exogenous state information are inputs to a second neural network which is connected as an input to the first neural network in a feedback loop. However, the solution fits only the demand response service for utility, which has a totally different distribution of energy compared to cellular networks.

None of the currently available approaches consider any assumption about mobile networks or traffic load prediction, battery discharging to various RBSs, and the resulting coupling constraints.

### SUMMARY

An objective technical problem to be solved by embodiments of the present disclosure is how to improve utilization of energy in energy storages that are arranged in a network and reduce carbon footprint and/or energy costs.

One aspect of the present disclosure provides a computer-implemented method for managing a plurality of energy storages at a plurality of sites in a network. The method comprises: acquiring a first dataset including power consumption data of at least a subset of the plurality of energy storages over a predetermined amount of time, generating a first simulated environment of the network based on the acquired first dataset, and training a first reinforcement learning system. Training of the first reinforcement learning system includes performing the following steps iteratively until a termination condition is met: selecting an action from a set of feasible actions, each action in the set of feasible actions being bounded by a set of constraints; calculating a reward of the selected action based on the generated first simulated environment of the network; and training the first reinforcement learning system to maximise reward for a given state of the network, based on the calculated reward for the selected action.

Another aspect of the present disclosure provides a computer program comprising instructions which, when executed by processing circuitry, cause the processing circuitry to perform the method as described herein.

Another aspect of the present disclosure provides a system for managing a plurality of energy storages at a plurality of sites in a network. The system comprises: an acquiring unit configured to acquire a first dataset including power consumption data of at least a subset of the plurality of energy storages over a predetermined amount of time, a generating unit configured to generate a first simulated environment of the network based on the acquired first dataset, and a training unit configured to train a first reinforcement learning system by performing the following steps iteratively until a termination condition is met: selecting an action from a set of feasible actions, wherein each action in the set of feasible actions is bounded by a set of constraints, calculating a reward of the selected action based on the generated first simulated environment of the network, and training the first reinforcement learning system to maximise reward for a given state of the network, based on the calculated reward for the selected action.

Another aspect of the present disclosure provides a system for managing a plurality of energy storages at a plurality of sites in a network. The system comprises processing circuitry coupled with a memory. The memory comprises computer readable program instructions that, when executed by the processing circuitry, cause the system to: acquire a first dataset including power consumption data of at least a subset of the plurality of energy storages over a predetermined amount of time; generate a first simulated environment of the network based on the acquired first dataset; and train a first reinforcement learning system by performing the following steps iteratively until a termination condition is met: selecting an action from a set of feasible actions, wherein each action in the set of feasible action is bounded by a set of constraints, calculating a reward of the selected action based on the generated first simulated environment of the network, and training the first reinforcement learning system to maximise reward for a given state of the network, based on the calculated reward for the selected action.

According to the one or more aspects of the present disclosure, by considering the load of all connected RBSs, and/or the possibility of an energy storage (e.g., a battery) to supply multiple RBSs, energy storages being arranged in a network can be utilized more efficiently in utility operations. Therefore, operators can significantly reduce their carbon footprint and/or energy costs, reduce the use of cables and the number of Power Supply Units (PSUs), lower site fuse costs, and improve robustness against power grid failures. Moreover, by applying the technique as disclosed herein according to the one or more aspects of the present disclosure, green energy power sources may be used to charge the energy storages and thereby take Radio Access Network (RAN) towards zero-emissions.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic diagram of a network including a plurality of orchestrated batteries, a charging orchestrator, an Orchestrator and Management (O&M) module, and an Operations Support System (OSS), according to embodiments of the disclosure;

FIG. 2 is a schematic diagram illustrating a number of examples of different modalities, according to embodiments of the disclosure;

FIG. 3 is a sequence diagram of a training and operational process for an RL agent according to embodiments of the disclosure;

FIG. 4 is a flow chart illustrating a method for managing a plurality of energy storages at a plurality of sites in a network, according to embodiments of the present disclosure; and

FIG. 5 is a block diagram of a system for managing a plurality of energy storages at a plurality of energy storages at a plurality of sites in a network, according to embodiments of the present disclosure; and

FIG. 6 is a block diagram of a system for managing a plurality of energy storages at a plurality of energy storages at a plurality of sites in a network, according to embodiments of the present disclosure.

### DETAILED DESCRIPTION

The carbon footprint of mobile networks heavily depends on the power source usage and the location of RBSs. For example, different access nodes (or RBSs) in a network may have different configurations and/or different equipment related to different radio traffic demands. For example, access nodes located in urban areas may have different configurations compared to access nodes located in rural areas, due to the difference in density of the environment. These differences can affect the carbon footprint of a network. Also, the location of access nodes (or RBSs) can affect carbon footprint of the network in two ways. The first relates to the limitations related to the site fuse in the power grid infrastructure. The second relates to whether the access nodes are located in an urban area or a rural area—for example access nodes located in rural areas (and have configuration(s) designed for use in rural areas) consume less power and use less radio traffic.

Recent market analyses reveal that telecoms operators are moving from lead-acid batteries to lithium-ion batteries. Amongst other benefits, these batteries do not require full charge and therefore capable of operating in partial and random charge situations using multiple cycles. This further suggests that these types of batteries can be leveraged as active power components in the networks for better power management and reducing the total cost of ownership (TCO). However, there are several existing issues associated with the management of batteries arranged typically in a communication network. These include:
Type of batteries: Frequency of charging/discharging may not be desirable for some types of batteries if it damages and reduces the battery lifetime, since it may lead to a higher TCO.
Charge policy: When and how much to charge the various battery technologies at specific times is important. Different battery types may have different charging cost profiles based on their locations, technologies, and charging times. Consequently, each battery type may require a specific optimised rate of charging, depending on these variables.
Discharge policy: When and how much to discharge to every connected RBS in the network is an essential aspect to consider. It is desired that a battery shares its available energy resources among various RBSs based on the battery technology, prediction of their load, cost, and other local factors (including humidity, temperature, room solution, etc.).
Type of environment and location of the batteries: High temperatures would degrade batteries faster compared to relatively low ambient temperatures.

Furthermore, network cognition that was mainly founded for network troubleshooting has evolved a lot. For scenarios where networks are fully automated, this network cognition can be used not only for improving the reliability of communication networks, but also for decreasing the energy footprint of communication networks. According to at least some embodiments described herein, traffic load predictions may be used in the management of batteries (or more generally, energy storages) in a network. Various radio traffic conditions may be a predeterminant for the prediction of upcoming traffic, and this can be fed into the active battery management solution proposed herein.

In current systems, batteries are used as a backup for energy storage at site infrastructure (comprising a plurality of sites, e.g. network nodes, radio base stations, or electric vehicle charging stations) so that they can be used in case of power outage. The site battery is dimensioned according to local regulations and the average power consumption needed for each site. Energy storages being arranged in a network can also be utilized more efficiently in other type of services, such as utility operations. Some of the embodiments described herein propose replacing the concept of “battery as backup power supply” with “battery as a new active power supply”, so as to substantially reduce the operational cost as well as carbon footprint when the batteries are charged and discharged intelligently.

In more detail, some of the embodiments described herein disclose a battery management technique that can be optimised for certain radio systems, by considering the time-varying radio traffic load and energy demands of RBSs to find the optimal state of charge (SOC) for the energy storages in a network. The optimal discharging policy may depend on the traffic load of multiple RBSs. Some of the embodiments described herein disclose a technique that involves the use of collected data relating to power consumption and/or energy cost of the sites in a network as well as the charging profiles of the batteries over time in training a reinforcement learning (RL) agent, where the RL agent that optimises battery technology (Valve Regulated Lead Acid (VRLA), Li-ion, sodium, etc.), the SOC of the batteries (i.e., when to charge each battery and when and how much to discharge for each connected site), and/or the total energy cost of RAN. The battery network proposed in some of the embodiments herein is beyond the existing concept of “battery as a backup solution” where one battery unit is provided per site to operate in case of power grid outage. It is also noted that the proposed solution described herein, more specifically the design of the battery network (BN), can be used in other sectors such as Electric Vehicle (EV) charging stations.

The technique described according to at least some embodiments of the present disclosure when applied in the context of RAN can improve RAN energy efficiency, as enabled by machine learning (ML). Specifically, according to at least some embodiments of the disclosure this can be achieved by considering the load of all connected RBSs, and/or the possibility of an energy storage (e.g., a battery) to supply multiple RBSs. Green energy power sources may be used to charge the energy storages and thereby take RAN network towards zero-emissions. Moreover, energy storages can supply power to other networks (e.g., EV charging stations) when the mobile network operator does not demand all the capacity of the energy storages. This can occur frequently overnight and during other lower traffic periods.

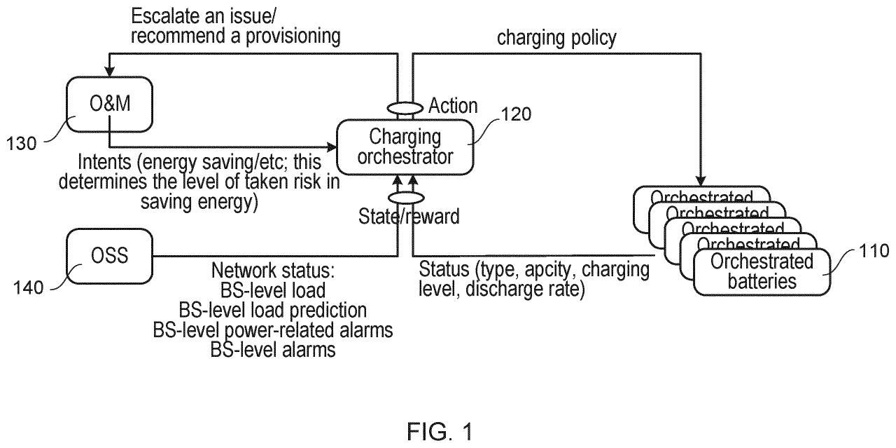

FIG. 1 is a schematic diagram of a network including a plurality of orchestrated batteries 110, a charging orchestrator 120, an Operations Administration and Maintenance (O&M) module 130, and an Operations Support System (OSS) 140, according to some of the embodiments of the disclosure. The plurality of orchestrated batteries 110 can be regarded as a BN, and the batteries are connected to various sites and locations. For illustrative purposes, the network shown in FIG. 1 is associated with a (wider) mobile network.

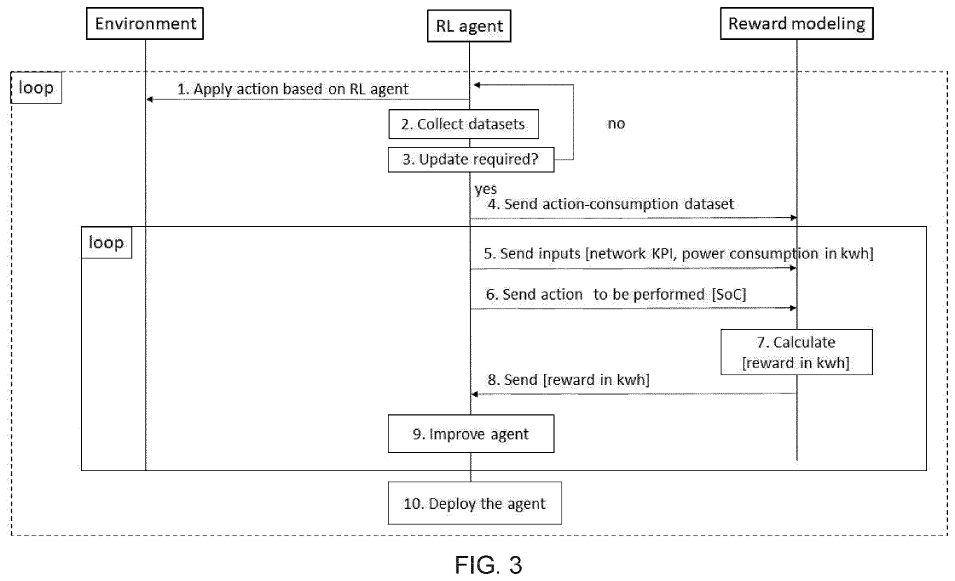

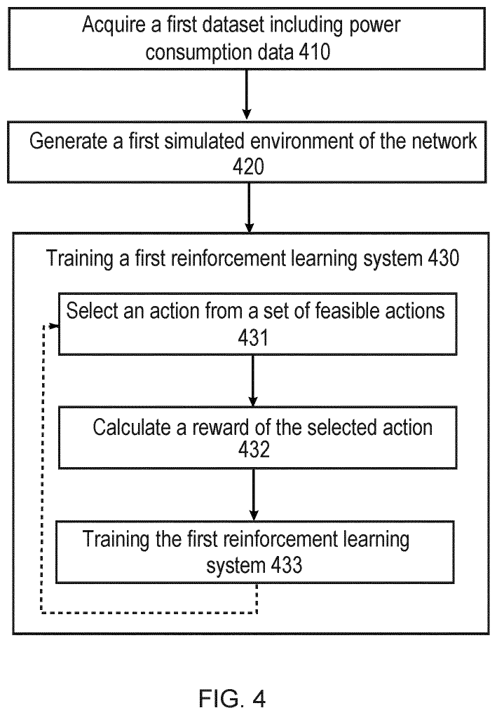

The charging orchestrator 120 can handle and optimise the BN with respect to relevant optimisation parameters(s), which will be explained in more detail with respect to FIG. 3 and FIG. 4. Furthermore, the charging orchestrator 120 can execute the processes and/or methods as described with respect to FIG. 3 and FIG. 4.

The O&M module 130 can be regarded as the “terminal” and the software for operating the charging orchestrator 120. The O&M module 130 can be implemented in a cloud or located in a separate location (from the BN, the charging orchestrator 120, and the OSS 140. The OSS 140 is a support system at which configuration and performance management (including key performance indicators (KPIs)) is handled. The OSS 140 can be implemented in a cloud.

It will be appreciated that in some embodiments the BN (or more generally, a plurality of energy storages that are configured to power a number of sites in a network) can serve as a distributed generation system to empower EV charging stations. Alternatively, the BN can serve a cellular network that also empowers EV charging stations with its excess energy. This may be beneficial for network operators as an extra revenue stream can be generated by selling extra energy over night when the traffic load of the cellular network is lower enough to leave extra unused energy in the batteries.

In this arrangement, time and location dependent costs (in terms of carbon footprint and/or money) are associated with charging the batteries. It is desired to minimise the total energy cost of mobile network operation by adopting optimal policies to charge and discharge the batteries within the BN. The batteries within the BN may be associated with different types of battery technologies, such as valve regulated lead-acid (VRLA), Lithium-ion (Li-ion), Sodium, etc.

The technique proposed herein can improve/reduce the total energy cost of operation in terms of energy bill and/or carbon footprint by using a network of rechargeable energy storages and to reduce utilization of the power grid, especially during peak hours. The energy management technique proposed herein can allow power to be delivered from two different sources (e.g., power grid and battery) during normal network operation, while considering various energy storage technologies, network traffic demands at various locations, and charging profiles and costs for the multiple nodes in the network.

According to some of the embodiments of the present disclosure, the proposed technique involves using collected data on power consumption of the sites in a network over time and training an episodic RL agent. For example, each episode duration may be set as 1 day, as data shows statistical regularity among different days. Nevertheless, the episode duration can be a variable (hyperparameter) that can be optimised by hyperparameter optimisation techniques, e.g., grid search or Bayes search. One episode can be further divided into a set of decision windows (e.g., which decision window duration being one hour). Similarly, the duration of a decision window is a parameter that can be optimised, by for example hyperparameter optimisation (e.g. a grid search or a Bayes search). At each decision window, the RL agent can acquire the required inputs and optimises for the next window a state of charge of energy storage(s), i.e., when to charge each energy storage, when and how much to discharge energy storage(s) associated with each site). This may be dependent on the energy storage type (battery type in this example), e.g., Valve Regulated Lead Acid (VRLA), Lithium-ion, sodium, etc.

The RL agent can use actions to minimise the total energy cost of RAN, including costs to charge the energy storages (based on respective charging price profiles and/or battery technologies) as well as the cost profile of the local power grid. Some battery technologies do not favour frequent charge and discharge—this can be modelled by an input charge/discharge cost function.

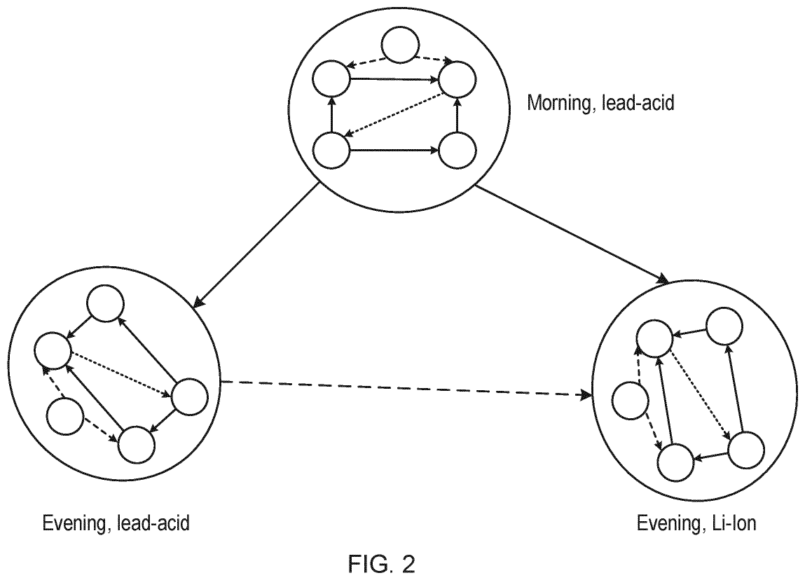

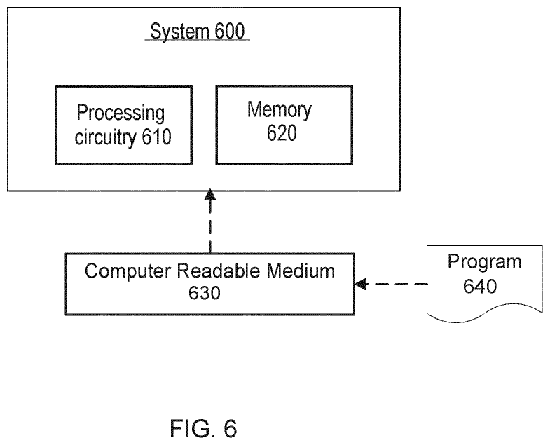

To perform the optimization, the RL agent can learn from the collected data. In some embodiments, which will be explained in more detail below with reference to FIG. 6 and FIG. 7, different models can be trained with respect to different modalities, wherein the different modalities corresponding to a battery technology and/or a network condition. FIG. 2 illustrates several examples of different modalities. As shown in FIG. 2, there is provided a modality associated with “evening” and “lead-acid”, e.g., “evening” characterising the traffic conditions that are associated with evening time in the network, and “lead-acid” being the associated battery technology. There is also provide a different modality associated with “morning” and “lead-acid”, and another different modality associated with “evening” and “Li-ion” (i.e., lithium-ion battery).

To optimise the decision variables, a set of constraints comprising one or more of the below may be applied:
Constraint 1: For every site, the power input from energy storage(s) plus the power input from the power grid at a time should be identical to output power of that site. This output can be provided in the dataset and subsequently used in the training of the RL agent
Constraint 2: For every energy storage (e.g., battery), the discharge during every decision window should not exceed the energy level at the beginning of said window plus the charging profile limit of said window
Constraint 3: For every energy storage, the current energy level should be identical to a previous battery level plus the amount of charging in this window minus the discharge rate

Constraint 4: For every energy storage, the battery level in any window should not exceed the battery capacity
Constraint 5: When charging energy storages at multiple sites, ensure that a resultant power peak caused by the multiple energy storages is within an allowed threshold

An objective of the technique, at least according to some of the embodiments of the present disclosure, is to minimise the total cost of RAN including the cost of charging energy storages and the cost to reduce the use of the power grid, while satisfying the constraints as set out above. The RL agent can automatically consider the network load and energy demands of neighbouring sites (or cells) and determine optimal states of charge for the energy storages based on their technologies.

### Machine Learning

As mentioned above, an episodic RL where each episode duration is a day can be used. The training of the RL agent can be performed in a cloud implementation or in any of the plurality of nodes in the network (e.g. RBS, core node, etc.). Also, the trained RL agent can be deployed at a battery management service which is located at each local battery at each site in a network. The technique can therefore be regarded as two phases: a development phase and a deployment phase. These phases can interact in a loop.

At the development phase, the RL agent can be developed with the following definitions:
A dataset includes power consumption information of various sites in a network over a plurality of episodes (e.g., days). The dataset can help simulate the network operation for pre-training or training the RL agent and thereby minimise the risk of poor performance in the deployment (or “operational”) phase
The states in the context of RL would comprise: current energy level (or more specifically battery level in some cases) of every energy storage, current output power of every site, current charging cost and so on.
The actions in the context of RL would be the charge and discharge decisions at an energy storage to the associated sites, and the corresponding rate of charge or discharge of the energy storage
The reward in the context of RL for every state-action would be inversely proportional to the total cost of input power (in kilowatts hour, related to energy). The cost may be a weighted sum of power from the power grid and power from the local energy storage over one decision window (e.g., one hour, but the decision window duration can be set to other values), where the weights are based on their own costs. The cost may be, among others, monetary cost of energy or a carbon footprint index. Moreover, the cost may be dependent on battery technology. For example, technologies that do not favour frequent charge/discharge may be associated with a higher energy cost function. The relevant cost models are provided as input to the RL agent. In some cases, the calculation of reward may be based on a sum of multiple cost models (e.g., a cost model related to battery technology, a cost model related to input power, etc.)

As mentioned above, the energy storages (e.g., batteries) can be used to empower EV charging stations, or the energy storages can serve a cellular network while empowering EV charging stations with its excess energy. In this case, the cellular network constraints/objectives (like serving a certain traffic demands or site limitations) may be adapted such that they are appropriate for an EV charging network.

In the initial training phase, the RL agent can acquire key performance indicator(s) (KPIs) of the cellular network (such as network traffic, latency, link reliability, etc.) and power consumption data from the environment simulator. This simulator provides a simulated environment of the network based on the collected dataset that includes power consumption information of various sites. The state of the simulated environment is mapped to an environment state and fed to the RL agent. The RL agent can then compute the next action and the corresponding reward and improve the RL agent and actions iteratively to find the optimal battery management policy. Afterwards, the trained RL agent can be deployed at the battery management service, i.e., can be deployed and executed from any of the plurality of nodes in the network (e.g., RBS, core node, etc.), or it can be deployed and executed in a cloud implementation. KPIs can be continuously monitored to trigger potential retaining or fine-tuning of the RL agent.

### Deployment

As described above, in the development phase, reward modelling can be performed using the simulated environment of the network. The reward may be represented by a measurement of power consumption measure over time, expressed in kwh.

After deployment, KPIs of the network as well as the average reward achieved by the RL agent can be continuously monitored. If the KPIs do not meet associated thresholds/ranges as defined, or if the distribution of the rewards is every different from that in the development phase (e.g., based on a tolerance on KPI degradation or other statistical distance measures such as Kullback-Leibler (KL) divergence or Bhattacharyya distance) between distribution of the reward (in kwh) of RL agent in the deployment phase and in the development phase, a significant change in the environment can be identified as needed and another development phase can be triggered. Once the development phase is completed (again), the retrained RL agent can be deployed. The development phase and the deployment phase therefore form a loop.

FIG. 3 is a sequence diagram of a training and operational process for an RL agent according to embodiments of the disclosure, which can be regarded as a sequence diagram for the operations with reference to “machine learning” and “deployment” as described above. As shown in FIG. 3, the process includes an outer loop and an inner loop. The outer loop corresponds to deployment of the RL agent (i.e. “deployment phase”), and the inner loop corresponds to training of the RL agent (i.e. “development phase”). The sequence of actions in FIG. 3 is based on the assumption that a trained RL agent is already provided initially (before step 1).

Step 1 of FIG. 3 corresponds to applying an action based on the (trained) RL agent to the environment. Step 2 of FIG. 3 corresponds to collection of datasets, for example KPIs of the network and/or the average reward achieved by the RL agent as described above. Step 3 of FIG. 3 corresponds to the step of determining whether the RL agent needs to be updated. This determination may be based on checking whether KPIs meet their associated thresholds/ranges, or whether the distribution of the rewards achieved by the RL agent is every different from that in a previous development phase.

If it is determined at step 3 that no update is required, the method returns to step 1 at which action(s) are applied to the environment based on the RL agent. If it is determined that an update is required at step 3, the method proceeds to step 4 at which a dataset of actions and corresponding energy consumption are sent by the RL agent to a reward modelling module. The dataset of actions and corresponding energy consumption corresponds to the actions applied in a previous deployment (or “operational”) phase and the corresponding resulting energy consumption.

Subsequently, at steps 5 and 6 (which are part of the inner “development” loop), inputs such as network KPIs and power consumption (in kwh) as well as the feasible action to be performed is sent from the RL agent to the reward modelling module, and at step 7 the reward modelling module calculates the reward associated with the actions and returns the calculated reward to the RL agent, which is then used to improve the RL agent at step 9. Steps 5 to 9 of the inner loop can be performed in iteration until a termination condition is met (e.g. the latest calculated reward having a value higher than a predetermine threshold). If the termination condition is met, the method can then proceed to step 10 at which the RL agent is deployed. The method subsequently returns to step 1.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

FIG. 4 is a flow chart illustrating a computer-implemented method for managing a plurality of energy storages at a plurality of sites in a network, according to embodiments of the present disclosure. In some embodiments, the plurality of sites may be regarded as respective individual nodes in the network. For example, a site may correspond to a RBS in the network, or EV charging station in the network, where the network may comprise at least one of: one or more of RBSs and one or more EV charging stations. It will be understood that the energy storages referred to herein are rechargeable energy storages such as rechargeable batteries.

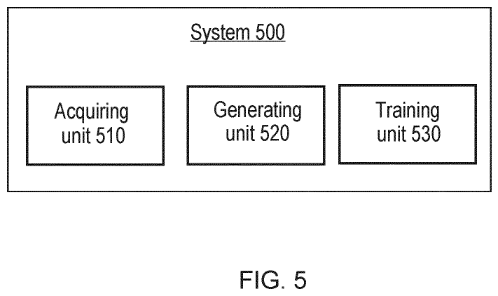

The illustrated method can generally be performed by or under the control of a combination of units or modules such as the acquiring unit, the generating unit, and the training unit of the system 500 as will be described below with reference to FIG. 5, or either or both of processing circuitry and memory, such as a processing circuitry coupled to a memory in a system (e.g. the components shown in FIG. 6).

With reference to FIG. 4, at step 410, a first dataset is acquired, where the first data set includes power consumption data of at least a subset of the plurality of energy storages over a predetermined amount of time, wherein the predetermined time is set based on the system requirements.

Then, at step 420, a first simulated environment of the network is generated based on the first dataset acquired at step 410. The simulated environment may reflect a current state of the network as is, or in some embodiments the simulated environment may reflect a potential different configuration of energy storages with respect to the plurality of sites.

Subsequently, at step 430, a first RL system is trained by performing the following steps iteratively until a termination condition is met:
Sub-step 431: selecting an action from a set of feasible actions, where each action in the set of feasible actions is bounded by a set of constraints, and in some embodiments the selected action in a current iteration may be different from an action selected in a previous iteration;
Sub step 432: calculating a reward of the selected action based on the generated first simulated environment of the network, where the reward may be inversely proportional of a total cost of input power, and where the total cost may correspond to at least one of a monetary cost and a carbon footprint cost; and
Sub-step 433: training the first RL system to maximise reward for a given state of the network, based on the calculated reward for the selected action.

In more detail, the selection of an action at sub-step 432 may be considered as a step of selecting an action for the purpose of reward modelling. This reward modelling operation corresponds to sub-step 432 described above where an associated reward is calculated (or modelled) based on the first simulated environment of the network.

In some embodiments, the method may further comprise acquiring one or more cost models, and in these embodiments calculating a reward at sub-step 432 may be based on acquired one or more cost models. The one or more cost models may include, for example, a cost model related to battery technology, a cost model related to input power, etc.

The cost model related to battery technology may model the cycle cost related to the specific battery technology (e.g. VLRA, Li-ion, sodium) used. The cost model may be a predefined mathematical model of the energy cost, namely the cost of charging/discharging a battery at a predefined time, predefined temperature conditions, and specific power supply (e.g. grid, renewable, etc.).

The cost model related to input power may show the cost of power consumption from the power grid at a certain time and location, and this cost model can be provided by a provider of the energy storage (e.g. a utility provider) or a third party. The cost model related to input power may be a metric that is obtained from the watt hours (i.e. energy capacity of the energy storage) used at the site and/or the performance indexes of the site.

The termination condition may be one of: the reward associated with the latest selected action being lower or equal in value to the reward associated with the selected action in the previous iteration, and the value of the reward associated with the latest selected action exceeding a predetermined threshold.

In some embodiments, each action in the set of feasible actions may include at least one of: charging one or more energy storages in the plurality of energy storages and corresponding one or more charging rates, and discharging one or more energy storages in the plurality of energy storages and corresponding one or more discharging rates, and adjusting a configuration of one or more energy sources in the plurality of energy storages.

In some embodiments, the set of constraints (binding each action in the set of feasible actions) may include one or more of:
a first constraint dictating that, for each of the plurality of sites, the value of the power input from a one or more energy storage corresponding to the respective site is identical to the value of the power output at the respective site
a second constraint dictating that, for each of the plurality of energy storages, the value of discharge during a time window should not exceed the value of an energy level at the beginning of the time window plus a value of charge limit for the time window
a third constraint dictating that, for each of the plurality of energy storages, the value of the current energy level is identical to the value of a previous energy level plus the value of charge during the respective time window and minus an amount of discharge during the time window
a fourth constraint dictating that, for each of the plurality of energy storages, a value of energy level at any time window should not exceed a respective capacity of the energy storage
a fifth constraint dictating that, when charging an energy storage from a plurality of storages, the resultant energy level caused by the plurality of storages is below a predetermined threshold.

In some embodiments, calculating a reward of the selected action at sub-step 432 may comprise performing the below steps:
acquiring initial observations characterising an initial state of the first simulated environment prior to the selected action being executed, where the observations may comprise at least one of: an energy level of each of the plurality of energy storages, a current power output of each of the plurality of energy storages, a current charging cost of each of the plurality of energy storages, and a battery type of each of the plurality of energy storages;
executing the selected action in the first simulated environment;
acquiring updated observations characterising an updated state of the first simulated environment subsequent to the selected action being executed; and
calculating the reward of the selected action based on the initial observations and the updated observations.

In some embodiments, the first RL system (or any other RL systems that are described with reference to FIG. 4) may be an episodic reinforcement learning system. In these embodiments, an episode associated with the first reinforcement learning system may be divided into a plurality of decision time windows, and each iteration in the training of the first RL system may correspond to a decision time window. Moreover, in these embodiments, at least one of the duration of the episode associated with the first RL system and the duration of the decision time window corresponding to each iteration can be regarded as hyperparameters and optimally determined by a hyperparameter optimisation technique. The hyperparameter optimisation technique may comprise at least one of a grid search and a Bayes search.

In some embodiments, the first dataset may correspond to a first modality, which corresponds to at least one of a first type of battery technology and a first type of network condition. In these embodiments, the method may further comprise:
acquiring a second dataset including power consumption data of at least a subset of the plurality of energy storages over a predetermined amount of time, where the second dataset corresponds to a second modality, the second modality corresponding to at least one of a second type of battery technology and a second type of network condition;
generating a second simulated environment of the network based on the acquired second dataset; and training a second RL system.

Training the second RL system may be achieved by performing the following steps iteratively until a termination condition is met:
selecting an action from the set of feasible actions;
calculating a reward of the selected action based on the generated second simulated environment of the network; and
training the second RL system to maximise reward for a given state of the network, based on the calculated reward for the selected action.

Although not shown FIG. 4, in some embodiments the method may further comprise using the trained first RL system to determine an action for a current state of the network. The trained first RL system may be deployed to be used at each of the plurality of energy storages in the network. Furthermore, in these embodiments the method may further comprise:
monitoring at least one of a key performance indicator value of the network and an average reward value achieved by the trained first RL system; and
initiating retraining of the first RL system if the at least one of the key performance indicator value of the network and the average reward value achieved by the trained first RL system does not satisfy a corresponding predetermined threshold or a corresponding predetermined range.

Retraining of a RL system may involve performing sub-steps 431, 432, and 433 based on the same simulated environment of the network, or involve performing these steps based on an updated simulated environment of the network until a termination condition is met. For example, prior to the retraining, an updated dataset including power consumption data of at least a subset of the plurality of energy storages (over a specific duration) may be acquired, and an updated first simulated environment of the network may be based on the newly acquired dataset. Then, retraining of the RL system may be based on the updated simulated environment in a similar manner as described above.

It will be appreciated that although the steps in the method illustrated in FIG. 4 have been described as being performed sequentially, in some embodiments at least some of the steps in the illustrated method may be performed in a different order, and/or at least some of the steps in the illustrated method may be performed simultaneously.

According to the present disclosure, there may be provided a system comprising processing circuitry and a memory. The memory is coupled to the processing circuitry, and comprises computer readable program instructions that, when executed by the processing circuitry, cause the system to perform the method as described with reference to FIG. 4.

FIG. 5 is a block diagram of a system for managing a plurality of energy storages at a plurality of energy storages at a plurality of sites in a network, according to embodiments of the present disclosure. In some embodiments, the plurality of sites may be regarded as respective individual nodes in the network. For example, a site may correspond to a

RBS in the network, or an EV charging station in the network, where the network may comprise at least one of: one or more of RBSs and one or more EV charging stations.

The system 500 comprises an acquiring unit 510, a generating unit 520, and a training unit 530. The acquiring unit 510 is configured to acquire a first dataset including power consumption data of at least a subset of the plurality of energy storages over a predetermined amount of time.

The generating unit 520 is configured to generate a first simulated environment of the network based on the acquired first dataset. The simulated environment may reflect a current state of the network as is, or in some embodiments the simulated environment may reflect a potential different configuration of energy storages with respect to the plurality of sites.

The training unit 530 is configured to train a first RL system by performing the following steps iteratively until a termination condition is met:
selecting an action from a set of feasible actions, where each action in the set of feasible actions is bounded by a set of constraints, and the selected action in a current iteration may be different from an action selected in a previous iteration.;
calculating a reward of the selected action based on the generated first simulated environment of the network, where the reward may be inversely proportional of a total cost of input power, and the total cost may correspond to at least one of a monetary cost and a carbon footprint cost; and
training the first RL system to maximise reward for a given state of the network, based on the calculated reward for the selected action.

In more detail, the selection of an action at the training unit 520 as described above may be considered as a step of selecting an action for the purpose of reward modelling. This reward modelling operation corresponds to the next step described above where an associated reward is calculated (or modelled) based on the first simulated environment of the network.

In some embodiments, the acquiring unit 510 may be further configured to acquire one or more cost models, and in these embodiments the training unit 530 may be configured to calculate the reward based on acquired one or more cost models. The one or more cost models may include, for example, a cost model related to battery technology, a cost model related to input power, etc.

The termination condition may be one of the reward associated with the latest selected action being lower or equal in value to the reward associated with the selected action in the previous iteration, and the value of the reward associated with the latest selected action exceeding a predetermined threshold.

The set of constraints may include one or more of:
a first constraint dictating that, for each of the plurality of sites, the value of the power input from a one or more energy storage corresponding to the respective site is identical to the value of the power output at the respective site;
a second constraint dictating that, for each of the plurality of energy storages, the value of discharge during a time window should not exceed the value of an energy level at the beginning of the time window plus a value of charge limit for the time window;
a third constraint dictating that, for each of the plurality of energy storages, the value of the current energy level is identical to the value of a previous energy level plus the value of charge during the respective time window and minus an amount of discharge during the time window;
a fourth constraint dictating that, for each of the plurality of energy storages, a value of energy level at any time window should not exceed a respective capacity of the energy storage; and
a fifth constraint dictating that, when charging an energy storage from a plurality of storages, the resultant energy level caused by the plurality of storages is below a predetermined threshold.

In some embodiments, the training unit 530 may be configured to calculate a reward of the selected action by performing the following steps:
acquiring initial observations characterising an initial state of the first simulated environment prior to the selected action being executed; the observations may comprise at least one of: an energy level of each of the plurality of energy storages, a current power output of each of the plurality of energy storages, a current charging cost of each of the plurality of energy storages, and a battery type of each of the plurality of energy storages;
executing the selected action in the first simulated environment;
acquiring updated observations characterising an updated state of the first simulated environment subsequent to the selected action being executed; and
calculating the reward of the selected action based on the initial observations and the updated observations.

In some embodiments, each action in the set of feasible actions may include at least one of: charging one or more energy storages in the plurality of energy storages and corresponding one or more charging rates, and discharging one or more energy storages in the plurality of energy storages and corresponding one or more discharging rates, and adjusting a configuration of one or more energy sources in the plurality of energy storages.

In some embodiments, the first RL system may be an episodic RL system. In these embodiments, an episode associated with the first RL system may be divided into a plurality of decision time windows, and each iteration in the training of the first RL system may correspond to a decision time window. Furthermore, in these embodiments at least one of the duration of the episode associated with the first RL system and the duration of the decision time window corresponding to each iteration may be determined by a hyperparameter optimisation technique. The hyperparameter optimisation technique may comprise at least one of a grid search and a Bayes search.

In some embodiments, the first dataset acquired by the acquiring unit 510 may correspond to a first modality, which in turn may correspond to at least one of a first type of battery technology and a first type of network condition. In these embodiments, the acquiring unit 510 may be further configured to acquire a second dataset including power consumption data of at least a subset of the plurality of energy storages over a predetermined amount of time, where the second dataset corresponds to a second modality, which in turn may correspond to at least one of a second type of battery technology and a second type of network condition. The generating unit 520 may be configured to generate a second simulated environment of the network based on the acquired second dataset. Furthermore, the training unit 520 may be configured to train a second RL system by performing the following steps iteratively until a termination condition is met:
selecting an action from the set of feasible actions;
calculating a reward of the selected action based on the generated second simulated environment of the network; and
training the second RL system to maximise reward for a given state of the network, based on the calculated reward for the selected action.

Although not illustrated in FIG. 5, the system 500 may further comprise a determining unit configured to using the trained first RL system to determine an action for a current state of the network. In these embodiments, the trained first RL system may be deployed by the system 500 to be used at each of the plurality of energy storages.

Although not illustrated in FIG. 5, the system 500 may further comprise a monitoring unit configured to monitoring at least one of a key performance indicator value of the network and an average reward value achieved by the trained first RL system. In these embodiments, the training unit 530 may be further configured to initiate retraining of the first RL system if the at least one of the key performance indicator value of the network and the average reward value achieved by the trained first RL system does not satisfy a corresponding predetermined threshold or a corresponding predetermined range.

Retraining of a RL system may involve performing the functionalities of the training unit 530 as described above until a termination condition is met. For example, prior to the retraining, the acquiring unit 510 may acquire an updated dataset including power consumption data of at least a subset of the plurality of energy storages (over a specific duration), and the generating unit 520 may generate an updated first simulated environment of the network may be based on the newly acquired dataset. Then, retraining of the RL system may be carried out by the training unit 530 based on the updated simulated environment in a similar manner as described above.

It will be appreciated that FIG. 5 only shows the components required to illustrate an aspect of the system 700 and, in a practical implementation, the system 500 may comprise alternative or additional components to those shown. An alternative is shown in FIG. 6 which shows a system 600 for managing a plurality of energy storages at a plurality of energy storages at a plurality of sites in a network, according to embodiments of the present disclosure, which comprises processing circuitry 610 coupled to memory 620. In this embodiment, the memory 620 comprises computer readable program instructions that, when executed by the processing circuitry, cause the system 600 to carry out the method as illustrated in FIG. 4.

Any appropriate steps, methods, or functions may be performed through a computer program product that may, for example, be executed by the components and equipment illustrated in FIG. 5 and FIG. 6. For example, there may be provided a storage or a memory at the system 500 that may comprise non-transitory computer readable means on which a computer program can be stored. The computer program (e.g. program 640 shown in FIG. 6) may include instructions which cause the components of the system 500 or any operatively coupled entities and devices) to execute methods according to embodiments described herein. The computer program and/or computer program product may thus provide means for performing any steps herein disclosed.

As shown in FIG. 6, a local computing device may further comprise a computer readable storage medium 630. On this computer readable storage medium 630, a computer program 640 can be stored and the computer program 640 can cause the processor in the processing circuitry 610 and thereto operatively coupled entities and devices, such as the memory 620 etc. to execute methods according to the disclosure described herein. The computer program 640 may thus provide means for performing any steps as herein disclosed. In some embodiments, the computer-readable storage medium 630 may be a non-transitory computer-readable storage medium, such as memory stick, or stored in the cloud space.

Embodiments of the disclosure thus propose methods and systems for managing a plurality of energy storages at a plurality of sites in a network, which allow operators to significantly reduce their carbon footprint and/or energy costs, reduce the use of cables and the number of Power Supply Units (PSUs), lower site fuse costs, and improve robustness against power grid failures.

The above disclosure sets forth specific details, such as particular embodiments or examples for purposes of explanation and not limitation. It will be appreciated by one skilled in the art that other examples may be employed apart from these specific details.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1.-19. (canceled)

20. A computer-implemented method for managing a plurality of energy storages at a plurality of sites in a network, the method comprising:
generating a first simulated environment of the network based on a first dataset including power consumption data of at least a subset of the plurality of energy storages over a predetermined amount of time; and
training a first reinforcement learning system by performing the following operations iteratively until a termination condition is met:
selecting an action from a set of feasible actions, wherein each action in the set of feasible actions is bounded by a set of constraints;
calculating a reward of the selected action based on the generated first simulated environment of the network; and
training the first reinforcement learning system to maximize reward for a given state of the network, based on the calculated reward for the selected action.

21. The method according to claim 20, wherein each action in the set of feasible actions includes at least one of the following:
charging one or more energy storages in the plurality of energy storages and corresponding one or more charging rates,
discharging one or more energy storages in the plurality of energy storages and corresponding one or more discharging rates, and
adjusting a configuration of one or more energy sources in the plurality of energy storages.

22. The method according to claim 20, wherein calculating a reward of the selected action comprises:
acquiring initial observations of an initial state of the first simulated environment prior to the selected action being executed, wherein the initial observations comprise at least one of the following: respective energy levels of the plurality of energy storages, respective current power outputs of the plurality of energy storages, respective current charging costs of the plurality of energy storages, and respective battery types of the plurality of energy storages;
executing the selected action in the first simulated environment;
acquiring updated observations of an updated state of the first simulated environment subsequent to the selected action being executed; and
calculating the reward of the selected action based on the initial observations and the updated observations.

23. The method according to claim 20, wherein:
the first reinforcement learning system is an episodic reinforcement learning system,
each episode associated with the first reinforcement learning system is divided into a plurality of decision time windows, and
each iteration in the training of the first reinforcement learning system corresponds to one of the decision time windows.

24. The method according to claim 23, wherein at least one of the following is determined by a hyperparameter optimization technique: a duration of an episode associated with the first reinforcement learning system, and a duration of the decision time window corresponding to each iteration.

25. The method according to claim 24, wherein the hyperparameter optimization technique comprises at least one of a grid search and a Bayes search.

26. The method according to claim 23, wherein the set of constraints includes one or more of the following:
a first constraint that, for each of the plurality of sites, a value of power input from one or more energy storages corresponding to the site is identical to a value of power output at the respective site;
a second constraint that, for each of the plurality of energy storages, a value of discharge during a time window should not exceed a value of an energy level at a beginning of the time window plus a value of charge limit for the time window;
a third constraint that, for each of the plurality of energy storages, a value of a current energy level is identical to the following: a value of a previous energy level, plus a value of charge during a time window, minus an amount of discharge during the time window;
a fourth constraint that, for each of the plurality of energy storages, a value of energy level at any time window should not exceed a capacity of the energy storage; and
a fifth constraint that, when charging an energy storage from a plurality of energy storages, the resultant energy level caused by the plurality of energy storages is below a predetermined threshold.

27. The method according to claim 20, wherein the action selected in a current iteration is different from the action selected in a previous iteration.

28. The method according to claim 20, wherein:
the first dataset corresponds to a first modality including at least one of a first type of battery technology and a first type of network condition; and
the method further comprises:
generating a second simulated environment of the network based on a second dataset including power consumption data of at least a subset of the plurality of energy storages over a predetermined amount of time, wherein the second dataset corresponds to a second modality including at least one of a second type of battery technology and a second type of network condition; and
training a second reinforcement learning system by performing the following operations iteratively until a termination condition is met:
selecting an action from the set of feasible actions;
calculating a reward of the selected action based on the generated second simulated environment of the network; and
training the second reinforcement learning system to maximize reward for a given state of the network, based on the calculated reward for the selected action.

29. The method according to claim 20, wherein the reward is inversely proportional of a total cost of input power.

30. The method according to claim 29, wherein the total cost corresponds to at least one of a monetary cost and a carbon footprint cost.

31. The method according to claim 20, wherein the termination condition is one of the following:
the reward associated with the latest selected action being lower or equal in value to the reward associated with the selected action in the previous iteration, and
the value of the reward associated with the latest selected action exceeding a predetermined threshold.

32. The method according to claim 20, further comprising using the trained first reinforcement learning system to determine an action for a current state of the network.

33. The method according to claim 32, wherein the trained first reinforcement learning system is deployed at each of the plurality of energy storages.

34. The method according to claim 32, further comprising:
monitoring at least one of a key performance indicator value of the network and an average reward value achieved by the trained first reinforcement learning system; and
initiating retraining of the first reinforcement learning system if the at least one of the key performance indicator value of the network and the average reward value achieved by the trained first reinforcement learning system does not satisfy a corresponding predetermined threshold or a corresponding predetermined range.

35. A system configured to manage a plurality of energy storages at a plurality of sites in a network, the system comprising:
processing circuitry, and
memory operably coupled to the processing circuitry and storing computer readable instructions that, when executed by the processing circuitry, cause the system to:
generate a first simulated environment of the network based on a first dataset including power consumption data of at least a subset of the plurality of energy storages over a predetermined amount of time; and
train a first reinforcement learning system by performing the following operations iteratively until a termination condition is met:
select an action from a set of feasible actions, wherein each action in the set of feasible actions is bounded by a set of constraints;
calculate a reward of the selected action based on the generated first simulated environment of the network; and
train the first reinforcement learning system to maximize reward for a given state of the network, based on the calculated reward for the selected action.

36. The system according to claim 35, wherein each action in the set of feasible actions includes at least one of the following:
charging one or more energy storages in the plurality of energy storages and corresponding one or more charging rates, discharging one or more energy storages in the plurality of energy storages and corresponding one or more discharging rates, and adjusting a configuration of one or more energy sources in the plurality of energy storages.

37. The system according to claim 35, wherein execution of the instructions by the processing circuitry configures the system to calculate the reward of the selected action based on:
acquiring initial observations of an initial state of the first simulated environment prior to the selected action being executed, wherein the initial observations comprise at least one of the following: respective energy levels of the plurality of energy storages, respective current power outputs of the plurality of energy storages, respective current charging costs of the plurality of energy storages, and respective battery types of the plurality of energy storages;
executing the selected action in the first simulated environment;
acquiring updated observations of an updated state of the first simulated environment subsequent to the selected action being executed; and
calculating the reward of the selected action based on the initial observations and the updated observations.

38. The system according to claim 35, wherein:
the first dataset corresponds to a first modality including at least one of a first type of battery technology and a first type of network condition; and
execution of the instructions by the processing circuitry further configures the system to:
generate a second simulated environment of the network based on a second dataset including power consumption data of at least a subset of the plurality of energy storages over a predetermined amount of time, wherein the second dataset corresponds to a second modality including at least one of a second type of battery technology and a second type of network condition; and
train a second reinforcement learning system by performing the following operations iteratively until a termination condition is met:
selecting an action from the set of feasible actions;
calculate a reward of the selected action based on the generated second simulated environment of the network; and
train the second reinforcement learning system to maximize reward for a given state of the network, based on the calculated reward for the selected action.

39. The system according to claim 35, wherein execution of the instructions by the processing circuitry further configures the system to use the trained first reinforcement learning system to determine an action for a current state of the network.
